(19) United States
(12) Patent Application Publication
(10) Pub. No.: US 2025/0368541 A1
(43) Pub. Date: Dec. 4, 2025

(54) METHOD OF FILTERING TANNERY WASTEWATER AND A TANNERY WASTEWATER TREATMENT SYSTEM

(71) Applicant: ECCO Sko A/S, Bredebro (DK)

(72) Inventors: Thomas Gogsig, Bredebro (DK); Ilona Francisca Maria Coremans, Bredebro (DK); Aleksandar Mitic, Gorlev (DK); Laurent Lardon, Gorlev (DK); Lana Wolmarans, Bredebro (DK)

(21) Appl. No.: 18/876,624

(22) PCT Filed: Jun. 26, 2023
(86) PCT No.: PCT/DK2023/050166

§ 371 Date: Dec. 18, 2024

(30) Foreign Application Priority Data
Jun. 24, 2022 (DK) PA 2022 70340

(51) Int. Cl. C02F 1/00; C02F 1/44; C02F 1/50; C02F 1/66; C02F 3/28; C02F 103/24

(52) U.S. Cl. CPC C02F 1/001; C02F 1/441; C02F 1/444; C02F 1/50; C02F 1/66; C02F 3/2893; C02F 2103/24; C02F 2209/08; C02F 2209/36; C02F 2209/445

(57) ABSTRACT

A method of filtering tannery wastewater includes micro filtering a wastewater input of wastewater in at least one micro-filter, thereby splitting the wastewater input into a first retentate stream which includes organic compounds and a first permeate stream. The method further includes establishing, on the basis of the first permeate stream or a derivative thereof, a reverse osmosis input stream. The method further includes performing, on the basis of reverse osmosis input stream, a reverse osmosis filtering by a reverse osmosis filter, thereby establishing a reverse osmosis retentate stream and a reverse osmosis permeate stream. The wastewater includes one or more side streams of a tanning process.

### FIELD OF THE INVENTION

The invention relates to a method of filtering tannery wastewater according to claim 1 and a tannery wastewater treatment system according to claim 56.

### BACKGROUND OF THE INVENTION

In relation to leather industry processes the use of chemical compounds as water based or solvent based processing agents gives rise to different types of effluents which may typically constitute a challenge or a restriction to the efficiency of the process. Moreover, many industrial processes will produce complex waste, which sometimes must be treated with care. This is of course costly, and the post treatment of this wastewater may be energy consuming.

### SUMMARY OF THE INVENTION

The invention relates to a method of filtering tannery wastewater, the method including the steps of
micro filtering a wastewater input of said wastewater in at least one micro-filter (MF) thereby splitting the wastewater input into a first retentate stream (FRS) comprising organic compounds and a first permeate stream (FPS),
on the basis of said first permeate stream (FPS) or a derivative thereof establishing a reverse osmosis input stream (ROIS),
on the basis of said reverse osmosis input stream (ROIS) performing a reverse osmosis filtering by a reverse osmosis filter (ROF) thereby establishing a reverse osmosis retentate stream (RORS) and a reverse osmosis permeate stream (ROPS), and wherein said wastewater comprises one or more side streams of a tanning process.

Complex effluents, for example waste streams from tanning industries, contain a large variety of molecules, which can be valorized or handled in diverse ways if separated into different fractions. Additionally, the initial mixture would reduce the performance of separation techniques targeting the smallest molecules or particles, for example reverse osmosis membranes and potentially also have a negative impact on the water quality.

In this context, an ‘effluent’ should be understood as a liquid stream that comes out of a process and an influent comes into a process. Thus, in the present context, the effluent of an industry is what becomes the influent of the present filtering method and system. Such effluent may otherwise be discharged out of an industry/town to a water body, a local treatment plant or to a sewer.

Separation methods may be combined and applied in cascade, which may allow sequential removal of classes of compounds. As a result, the deterioration of separation technologies, for example caused by fouling of filtering elements, is limited.

The application of cascading membranes facilitates that the properties of each side stream may be applied for valorization and furthermore leads to protection of the subsequent filtering elements from harmful contaminants.

In the present context, a wastewater relatively rich in organic compounds may not necessarily be regarded and treated as problematic waste, but the wastewater treatment may in fact output valuable organic compounds, e.g. from an effluent of a tanning process step, which may be used for production of biogas in a biogas reactor and/or for production of other fuels.

A further advantageous feature is that the wastewater treatment system may reduce the hydraulic load as aerobic treatment may be reduced significantly compared to conventional wastewater treatment involving a biological treatment process as an initial treatment step and because the process provides a side stream comprising carbon compounds which may be applied e.g. for production of biogas and/or other fuels. Consequently, this may advantageously lead to a reduction of the net energy consumption and potentially also a reduction of net sludge production—and thus reduce the resulting sludge disposal.

Handling and treatment of such complex waste are costly and energy consuming in conventional treatment systems, and often lead to the destruction of the organic and mineral resources contained in the waste, whereas the present inventive wastewater treatment system both provides an efficient and reliable filter and at the same time features an improved net-energy.

In the present context, the term ‘wastewater’ is not only understood traditionally as sewage but also as effluent from an industrial process. Furthermore, the term ‘wastewater’ refers to the total available waste stream flow within the process in scope, and the term ‘wastewater input’ refers to one or more ‘sub streams’ from one or more individual process steps of the process in scope. Such sub streams may also be referred to as ‘side streams’. Consequently, when using the term ‘a subset of wastewater inputs’ or ‘a subset of side streams’ or ‘one or more sub streams’, it may refer to either one wastewater input (effluent from one process step), two or more wastewater inputs (effluent from two or more process steps), or to the overall term of wastewater (the total waste stream flow of the process). In the present context and if not stated otherwise, any effluent or sub stream may be suitable as a wastewater input to any level of filtering.

In other words, the total available waste stream may be filtered as a whole, or the method may be applied such the total wastewater is only partly filtered by performing the inventive filtering on one or more sub streams of the total available waste stream. It is also noted that some industrial processes providing the wastewater to be filtered is outputting a total combined liquid mass, where all ingredients to be filtered are in a mixed stream and therefore has to be dealt with as such, whereas processes involving separate process steps may advantageously be filtered according to the invention by individually filtering one or more separate side streams in order to optimize the individual filtering. Hence, a wastewater filtering according to the invention may imply that just one separate side stream is filtered, thereby still improving the total benefit, such as energy consumption, even if only part(s) of the wastewater is/are filtered.

In an embodiment of the invention, the wastewater comprises a subset of one or more side streams of a tanning process.

In an embodiment of the invention, the wastewater is provided on the basis of effluent from one or more tanning process steps.

In the present context, the method of filtering wastewater may advantageously be applied for treatment of effluent from a tanning process. A tanning process in the present context refers to a succession of tanning process steps by which raw animal hides are transformed into a so-called leather material. A tanning process step is to be understood as one subprocess of the total tanning process, e.g a soaking step, a liming step, a bating step, a pickling step, a tanning step, a fat liquoring step, and/or a drying step.

It goes without saying that the amount of organic compounds may vary, depending on whether effluents are provided from one individual tanning process step or from a combined subset of tanning process steps, or whether the filtration method is applied on the total wastewater pool (i.e. mixed from all or most of the relevant tanning process steps).

In the present context, a tanning process may both be referred to as a tanning process related to animal hides or alternatively also designate a tanning process related to source material other than animal. An example of such non-animal source material may include fungal mycelium. In such a setting, the tanning step of the tanning process may more accurately be referred to as a plastification step, e.g. in the form of a cross-linking step.

In an embodiment of the invention, the wastewater is an effluent from one tanning process step.

In an embodiment of the invention, the wastewater is an effluent from two or more tanning process steps.

In an embodiment of the invention, the effluent is provided from one or more tanning process steps of a tanning process, such as soaking, SOA, liming, LIM, deliming, DE-LIM, bating, pickling, tanning, TAN, dyeing, DYI, and fat liquoring, FAL.

In an embodiment of the invention the content of organic compounds of the first retentate stream (FRS) is at least 25%, such as at least 50%, such as at least 75% by weight of said wastewater input.

In the present context, it is understood that minor reductions in the organic content prior to subjecting the feed to the inventive process may be accepted, but in order to properly utilize the very attractive properties of the inventive process, this reduction should be kept as low as possible. The organic content may be obtained in a retentate filtered by the initial microfilter and optionally the permeate can be further filtered by downstream filters, such as nano-filters or ultra-filters in order to maximize the energy yield of the wastewater treatment.

In this context, a microfilter may be defined as a filter with open pore structures and a pore size between 5 nm and 2 micrometers, such as between 5 nm and 1 micrometer, such between as 5 nm and 200 nm, such as between 5 nm and 100 nm, such as between 5 nm and 60 nm, such as between 10 nm and 50 nm.

The process of microfiltration may advantageously include a pump fitted onto the processing equipment to allow liquid to pass through filtering element. Filtration through a microfilter may occur by cross-flow filtration or by dead-end filtration.

In an embodiment of the invention, the first retentate stream and/or a derivative thereof (FRS) is subjected to anaerobic digestion.

In the present context, it should be emphasized that the first retentate stream may be subjected to anaerobic treatment directly or advantageously be subject to anaerobic treatment after some intermediate treatment. Such intermediate treatment could e.g. be removal of ammonia or other compounds which are undesired for the intended conversion of the first retentate stream or a derivative thereof into biogas and/or other fuels.

In an embodiment of the invention, the first retentate stream and/or a derivative thereof (FRS) is subjected to anaerobic digestion and thereby converted to biogas.

In the present context, biogas and other types of fuels are attractive products of the first retentate stream as the biofuels represent a “reuse” or recovery of the waste which may in fact decrease the net energy consumption of the wastewater treatment system as the high energy gain obtained through the filtering of the organic compounds in the initial micro-filtering process may more than compensate for the relatively high power consumption related to the subsequent filtering, in particular the filtering based on reverse osmosis.

In an embodiment of the invention, the first retentate stream and/or a derivative thereof (FRS) and at least a second retentate stream and/or a derivative thereof (SRS) is subjected to anaerobic digestion.

In the present context, it should be emphasized that the first retentate stream and the second retentate stream may be subjected to anaerobic treatment directly or advantageously be subject to anaerobic treatment after some intermediate treatment. In other words, the second retentate stream or retentate from further downstream filters, e.g. nano- or ultra-filters, may also be used for manufacturing of biogas and/or other fuels if this is considered cost efficient.

In an embodiment of the invention, the first retentate stream and/or a derivative thereof (FRS) is subjected to anaerobic digestion and at least a second retentate stream (SRS) is subjected to aerobic treatment.

In the present context, it should be emphasized that the first retentate stream, FRS, may be subjected either directly or through an additional processing step to anaerobic treatment for the purpose of utilizing the inherent energy of the organic compounds. The second retentate stream, SRS, and potentially also retentate streams from filters further downstream in the process, may be subjected to aerobic treatment. In such a setup, the first retentate, preferably the largest and most significant side stream of the wastewater input may be reused for e.g. biogas and/or other fuels while the smaller side streams may be subject to a less energy-efficient process, but thereby still keeping the net energy of the method/system attractive.

In an embodiment of the invention, the content of organic compounds in the first retentate stream (FRS) is at least 25%, such as least 50%, such as at least 75% by weight of the organic compounds of the wastewater input, and where the content of organic compounds of the reverse osmosis input stream (ROIS) is less than 1% such as less than 0.001% by weight of the total reverse osmosis input stream (ROIS).

In an embodiment of the invention, the content of chemical oxygen demand (COD) of the wastewater input is 1 to 50 gram per liter, such as 2 to 20 gram per liter.

In an embodiment, the method may both establish a side stream of organic compounds which may be utilized e.g. for biogas and/or other fuels, e.g. by anaerobic treatment, but also, at the same time, establish a relatively clean output coming from the final filtration step, i.e. the reverse osmosis filter. The cleaned water output from the last filtration step may be reused in the wastewater treatment process or may be discharged.

Moreover, by keeping the concentration of organic compounds low on the reverse osmosis input stream, fouling of the membrane(s) of the reverse osmosis filter is minimized.

In an embodiment, 100% of particulate organic matter may be rejected by the microfilter.

In an embodiment of the invention, a reverse osmosis input stream (ROIS) is established at least partly by filtering the first permeate stream by one or more further filters.

In the present context, the meaning of a reverse osmosis input stream based on the first permeate stream is that the first permeate stream is subjected to filtration by reverse osmosis directly after the microfiltration step, i.e. without being filtered by intermediate filters before entering the reverse osmosis membrane(s), or typically, is subjected to filtration by reverse osmosis after one or several intermediate filtrations, e.g. nano- and/or ultra-filtration.

In this context, the initial micro-filtration will thus provide the bulk of the organic material used for organic compound energy retrieval, e.g. biofuel production, and the remaining filters may be applied for cleaning out of undesired ions such as NH4+, SO4, Ca2+ and S2−, etc., to a degree that allows the permeate of the reverse osmosis filtration to be either clean enough for discharge or at least applicable for reuse.

In an embodiment of the invention, on the basis of said first permeate stream (FPS) performing a nano-filtration thereby obtaining a second retentate stream (SRS) comprising further organic compounds and a second permeate stream (SPS).

In an embodiment of the invention, on the basis of said second permeate stream (SPS) providing a reverse osmosis input stream (ROIS) by filtering the first permeate stream by one or more further filtration units.

In an embodiment of the invention, at least the first retentate stream (FRS) or a derivative thereof is applied for production of biogas and/or other fuels.

In an embodiment of the invention, the wastewater input comprises effluent from a soaking step of a tanning process.

In an embodiment of the invention, the wastewater input comprises liming effluent from a tanning process.

In an embodiment of the invention, the wastewater input comprises de-liming effluent from a tanning process.

In an embodiment of the invention, the wastewater input comprises bating effluent from a tanning process.

In an embodiment of the invention, the wastewater input comprises pickling effluent from a tanning process.

In an embodiment of the invention, the wastewater input comprises rawhide salt dilution water.

In an embodiment of the invention, the wastewater input comprises digestate centrate.

In an embodiment of the invention, the wastewater input comprises fibres removed from animal hide prior to the tanning process and a pre-filter is applied for filtering of said fibres prior to said microfiltration.

In an embodiment of the invention, the wastewater input comprises effluent from a sammying step of a tanning process.

In an embodiment of the invention, the wastewater input comprises effluent from a neutralization step of a tanning process.

In an embodiment of the invention, effluents from a soaking and a bating step of a tanning process are combined.

In an embodiment of the invention, effluent from a liming step is treated individually.

In an embodiment of the invention, effluent from a pickling step is treated individually.

In an embodiment of the invention, the first retentate stream (FRS) comprises organic compounds such as dung, blood, urine, grease, non-structural proteins, hyaluronic acid and/or keratin.

In an embodiment of the invention, the first retentate stream (FRS) comprises in-organic compounds such as mud, soil, grit and/or sand.

In an embodiment of the invention, the second retentate stream (SRS) comprises organic molecules, such as smaller proteins, peptides, amino acids, organic acids, multivalent ions such as calcium, magnesium, sulphate, phosphate and/or any combination thereof.

In an embodiment of the invention, at least one of the retentate streams is fed back to an industrial process.

In the present context, a retentate stream is understood as a relevant retentate obtained from one or several of the filters downstream of the micro-filter.

In an embodiment of the invention, at least one of the retentate streams is fed back to a pickling step of a tanning process.

In an embodiment of the invention, at least one of the permeate streams is fed back to an industrial process.

In an embodiment of the invention, at least one of the permeate streams is fed back to a soaking step of a tanning process.

In an embodiment of the invention, the microfilter is implemented with one or more crossflow filtration elements.

In an embodiment of the invention, the pore size of the microfilter is between 5 nm and 2 micrometers, such as between 5 nm and I micrometer, such between as 5 nm and 200 nm, such as between 5 nm and 100 nm, such as between 5 nm and 60 nm, such as between 10 nm and 50 nm.

In an embodiment of the invention, at least one further filter comprises an ultrafilter and wherein the ultrafilter is implemented with one or more crossflow filtration elements.

In an embodiment of the invention, the pore size of the ultrafilter is between 0.1 nm and 2 micrometers.

In an embodiment of the invention, at least one further filter comprises a nano-filter and wherein the nano-filter is implemented with one or more crossflow membranes.

In an embodiment of the invention, the pore size of the nano-filter is between 150 Da (Dalton) and 1000 Da.

In an embodiment of the invention, the reverse osmosis filter is implemented with one or more crossflow membranes.

A crossflow filtration element or membrane as referred to above, when applied in relation to e.g. the microfilter, the ultrafilter, the nano-filter and/or reverse osmosis filter may be defined as a filtering element providing a crossflow filtration, also referred to as a tangential flow filtration (TFF).

Crossflow filtration is different from dead-end filtration in which the feed is passed through a filtering element, the solids being trapped in the filter and the filtrate being released at the other end. Crossflow filtration gets its name because the majority of the feed flow travels tangentially across the surface of the filter, rather than into the filter. The principal advantage of this is that the filter cake (which can blind the filter) is substantially washed away during the filtration process, increasing the length of time that a filter unit can be operational. It can be a continuous process, unlike batch-wise dead-end filtration.

The main driving force of a crossflow filtration process is transmembrane pressure. Transmembrane pressure is a measure of the pressure difference between the two sides of the filtering element.

In crossflow filtration, the feed is passed across the filtering element (tangentially) at positive pressure relative to the permeate side. A proportion of the material which is smaller than the pore size passes through the filtering element as permeate or filtrate; everything else is retained on the feed side of the filtering element as retentate.

With crossflow filtration, the tangential motion of the bulk of the fluid across the membrane causes trapped particles on the filter surface to be rubbed off. This means that a crossflow filter can operate continuously at relatively high solid loads without blinding.

Some benefits in the specific cascaded application(s) of crossflow filtering elements include, but are not limited to:
A higher overall liquid removal rate is achieved by the prevention of filter cake formation
Process feed remains in the form of a mobile slurry, suitable for further processing
Solid content of the product slurry may be varied over a wide range
It is possible to fractionate particles by size
Tubular pinch effect

Filtering elements in relation to crossflow filtration can be polymeric or ceramic, depending upon the application. The principles of crossflow filtration may in specific embodiments be used in reverse osmosis, nanofiltration, ultrafiltration and microfiltration.

In the present context, some types of crossflow filtering elements may be improved in relation to performance by e.g. applying backwashing. In backwashing, the transmembrane pressure is periodically inverted by the use of a secondary pump, so that permeate flows back into the feed, lifting the fouling layer from the surface of the membrane.

In the present context, an advantageous way of improving the industrial performance of a wastewater filtering within the scope of the invention, is to apply so-called cleaning-in-place systems (CIP).

The CIP process may use detergents, reactive agents such as acids and alkalis such as citric acid and sodium hydroxide (NaOH). Sodium hypochlorite (bleach) must be removed from the feed in some membrane plants. Bleach oxidizes thin-film membranes. Oxidation will degrade the filtering elements to a point where they will no longer perform at rated rejection levels and have to be replaced. Bleach can be added to a sodium hydroxide CIP during an initial system start-up before spirally-wound membranes are loaded into the plant to help disinfect the system. Bleach may also be used to metallic or ceramic filtering elements, as their tolerance for sodium hypochlorite is much higher than a spirally-wound membrane. Caustics and acids may also be used as primary CIP chemical. Caustic removes organic fouling and acid removes minerals. Enzyme solutions are also used in some systems for helping remove organic fouling material from the membrane plant. The pH and temperature are important to a CIP program. If pH and temperature are too high, the membrane may degrade and flux performance will suffer. If pH and temperature are too low, the system simply will not be cleaned properly. Every application has different CIP requirements. Each membrane manufacturer has their own guidelines for CIP procedures for their product.

Nevertheless, within the scope of the invention, it may be advantageous to sterilize one or more of the filtering elements of the microfilter, the ultrafilter, the nanofilter and/or the reverse osmosis filter with hot water. The cleaning method and the temperature must be adapted to the applied filtering element, so as to avoid degradation of the filtering element or to avoid damaging the filtering element.

In an embodiment of the invention, the pore size of the reverse osmosis filter is less than 150 Da.

In an embodiment of the invention, said first permeate stream (FPS) or a derivative thereof is subjected to an anti-microbial treatment prior to subjecting said first permeate stream or a derivative thereof to said reverse osmosis filtering by said reverse osmosis filter (ROF).

A reduction of the number of microbes would in the present invention at this stage of the process, preferably be performed without use of chemical compounds or e.g. enzymes.

In an embodiment of the invention, said first permeate stream (FPS) or a derivative thereof is subjected to an anti-microbial treatment prior to subjecting said first permeate stream or a derivative thereof to said reverse osmosis filtering by said reverse osmosis filter (ROF) and wherein the anti-microbial treatment is obtained by ultraviolet (UV) light.

Using UV light disinfection, the cell walls of bacteria, virus, and protozoa may be penetrated, and may thereby permanently alter the DNA of the microorganisms. This effectively may inactivate the microorganisms, making them unable to infect and reproduce. As far as the cells are not able to reproduce, they will not be able to cause any infection, thus killing the bacteria and viruses.

UV disinfection has become the preferred water disinfection solution to inactivate and kill microorganisms, bacteria, and viruses due to its many advantages, such advantages may e.g. include:
A lower carbon footprint compared to the alternative disinfection methods
Low maintenance, administration, and operating costs
No dangerous chemicals involved (no residuals, handling and storage)
No by-products being added in the process
No change in the water properties such as pH and temperature
“Instant” treatment, meaning there is only a very short processing time
Safe and simple implementation.

In an embodiment of the invention, said first permeate stream (FPS) or a derivative thereof is subjected to an anti-microbial treatment prior to subjecting said first permeate stream or a derivative thereof to said reverse osmosis filtering by said reverse osmosis filter (ROF) and wherein said reverse osmosis permeate stream (ROPS) is further subjected to an anti-microbial treatment.

In an embodiment of the invention, said reverse osmosis permeate stream (ROPS) is subjected to an anti-microbial treatment.

In an embodiment of the invention, said reverse osmosis permeate stream and/or said reverse osmosis retentate stream is subjected to an anti-microbial treatment by being chemically treated by chlorine, hydrogen peroxide and/or ozone.

By chemically treating the reusable permeate stream, it is thereby possible to reduce or remove the content of bacteria and viruses.

In an embodiment of the invention, said reverse osmosis permeate stream and/or said reverse osmosis retentate stream is UV radiated and/or subjected to filtration by an activated carbon filter.

By using UV (UV: ultraviolet) radiation, undesired microorganism content may be reduced or removed.

In an embodiment of the invention, any of said anti-microbial treatments is variably turned on and off in dependency of the microorganism level in a relevant water stream of the system.

In an embodiment of the invention, at least one of the permeate streams is fed back to be applied as a diluted version of the input wastewater in an industrial process.

In an embodiment of the invention, the tannery wastewater is further filtered with a prefilter prior to the application of said at least one microfilter.

In an embodiment of the invention, the tannery wastewater is further filtered with a prefilter prior to the application of said at least one microfilter thereby removing content of the wastewater which may not efficiently be removed by said at least one microfilter, e.g. solids, hair, etc. being a part of the wastewater being subject to filtration according to the invention.

In an embodiment of the invention, the tannery wastewater has not been subjected to aerobic pretreatment prior to said microfiltration.

In an embodiment of the invention, said microfilter is subject to a cleaning-in-place (CIP), and wherein the microfilter is cleaned at least one time every 7 days, such as at least at least one time every 6 days, such as at least at least one time every 5 days, such as at least at least one time every 4 days, such as at least at least one time every 3 days, such as at least at least one time every 2 days, such as at least at least one time every day.

The invention further relates to a wastewater treatment system (WWTS) comprising at least one wastewater system input (WSI), the wastewater system input (WSI) being fluidly connected with a micro filter (MF),
the micro filter (MF) being fluidly connected with a conduit (CON2) for channeling of a first retentate stream (FRS) or a derivative thereof to a system output (SO1),
the micro filter (MF) moreover being fluidly connected with a conduit for channeling of at least a sub stream of a first permeate stream (FPS) via one of more intermediate filters (NF) to at least one reverse osmosis filter (ROF),
the reverse osmosis filter (ROF) providing at least one reverse osmosis permeate stream to a system output (SO4).

In an embodiment of the invention, the reverse osmosis filter (ROF) provides at least one reverse osmosis retentate stream to a system output (SO3).

In an embodiment of the invention, said micro-filter (MF) is fluidly connected with a conduit for channeling of a sub stream of a first permeate stream (FPS) or a derivative thereof to a system output (SO2) via at least one intermediate filter (NF).

In the present context, an intermediate filter may typically materialize as a nano-filter or an ultra-filter.

In an embodiment of the invention, said first retentate stream (FRS) or at least a side stream thereof is channeled to a system output (SO1) via one or more filters.

In an embodiment of the invention, the tannery wastewater treatment system (WWTS) is operated according to the method of filtering tannery wastewater.

In embodiments, it may be advantageous to eliminate undesired compounds having a negative impact on a subsequent anaerobic treatment based on the first retentate stream.

### THE DRAWINGS

The invention will be described below with reference to the drawings of which

FIGS. 1a and 1b illustrate how effluents may be derived from different steps of a tanning process,

FIG. 2 illustrates principles of a water treatment system according to an embodiment of the invention,

FIG. 3 illustrates principles of a wastewater treatment system for treatment of tanning process effluents according to an embodiment of the invention, and where

FIG. 4 illustrates an implementation of a microfilter applicable in an embodiment of the invention.

### DETAILED DESCRIPTION

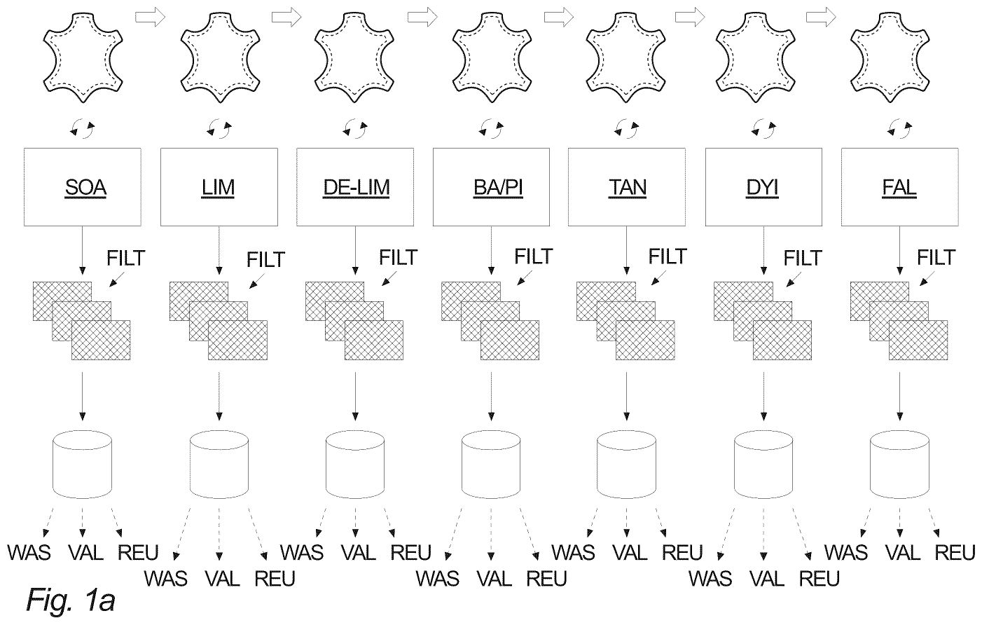

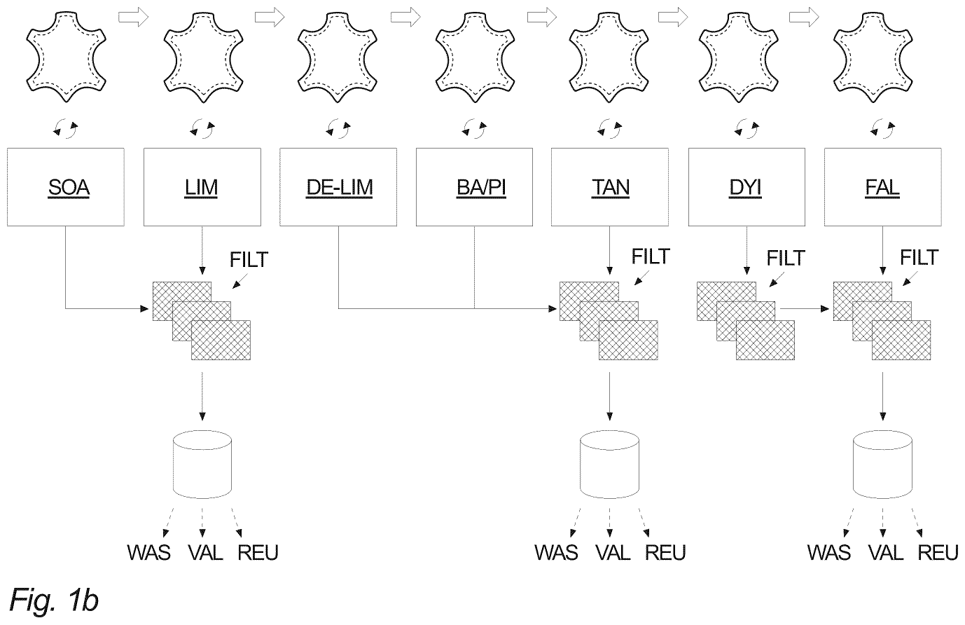

FIG. 1a illustrates an industrial process in which the inventive water treatment system and method may be implemented.

The illustrated process is a tanning process comprising the following steps: A soaking step, SOA, a liming step, LIM, a de-liming step, DE-LIM, a bating/pickling step, BA/PI, a tanning step, TAN, a dyeing step, DYI, and a fat liquoring step, FAL. The process as such is well-known in the art, and further steps may be included depending on the source material, e.g. type of leather, type of mycelium, etc. Some of the steps may also be split, repeated and/or switched according to different tanning process approaches, and some steps may be omitted and/or modified significantly depending on the application.

An example of a step which may be split is the bating/pickling step, which may typically be done in separate bating and pickling steps (not shown).

In some applications, it may be less attractive to treat wastewater sub streams from the tanning step, the dyeing step and the fat liquoring step.

Other applicable wastewater sub streams may originate from a fibre removal step of a tanning process, a sammying step of a tanning process, and/or a neutralization step of a tanning process. Other sub steams may include input streams obtained before the tanning process, e.g. in the form of a digestate centrate.

A further step which may be added is a process step prior to the tanning process, where salts are scraped from the hides.

With this in mind, the illustrated tanning process steps and their sequence may nevertheless, with the proper definitions, be performed in the order exemplified or with modifications.

Again, whichever sequence is to be applied, each individual tanning process step may result in an effluent.

As illustrated, each step of the process may be subject to filtering according to the provisions of the invention with a cascaded filtering arrangement, FILT. The filtering may result in a number of side streams which may be either cleaned and re-usable water, REU, streams suitable for valorization, VAL, and/or streams being subject to further treatment/degradation, WAS. The re-usable side streams are streams of water with very low amounts of dissolved solids and absence of suspended solids thereby being suitable for reuse. The streams suitable for valorization may be streams with either high energy content, high salinity content or high contents of other molecules of interest, such as ammonia or phosphate. The valorisation side streams can thus be utilised e.g. as feed-back streams for industrial processes such as tanning processes or for energy retrieval or for synthesizing a specific molecule of interest. Finally, the side streams being subject to degradation may contain the remaining stream of compounds which cannot be utilized further, and which are thus degraded by e.g. aerobic treatment.

The wastewater treatment according to the present invention will be described in more detail in the below figures.

FIG. 1b illustrates the above shown tanning process, but now some of the tanning process steps are combined to obtain side streams which fit into the desired outcome of the effluent treatment.

In the present embodiments, effluents from the soaking step, SOA, and the liming step, LIM, are combined into one process, and the treatment of the combined effluents produces cleaned water, REU, a valorized side stream, VAL, and a waste side stream, WAS, obtained from the combined tanning process steps of soaking, SOA, and liming, LIM.

In another embodiment, the soaking step, SOA, and the liming step, LIM, are isolated from one another, and their individual effluents are treated separately. An advantage may be that mixing the soaking and liming step effluents may lead to a decrease in the pH value, which may cause a release of hazardous gases.

Likewise, the effluents from the deliming step, DE-LIM, the bating/pickling step, BA/PI, and the tanning step, TAN, have been combined for treatment according to the invention, and finally the effluents from the dyeing step, DYI, and the fat liquoring step, FAL, have been combined.

Several other combinations may be applied within the scope of the invention considering the compounds of the respective effluents and thus, the valorization potential of each combination.

Non-limiting examples include: Rawhide salt dilution water, effluents from the soaking step and a bating step, effluents from the liming and de-liming steps, effluent from a pickling step, effluent from a digestate centrate obtained prior to the tanning process, combined effluents from a fibre removal step, a sammying step and a neutralization step, or a “one pot” of all or most of the sub streams of the tanning process.

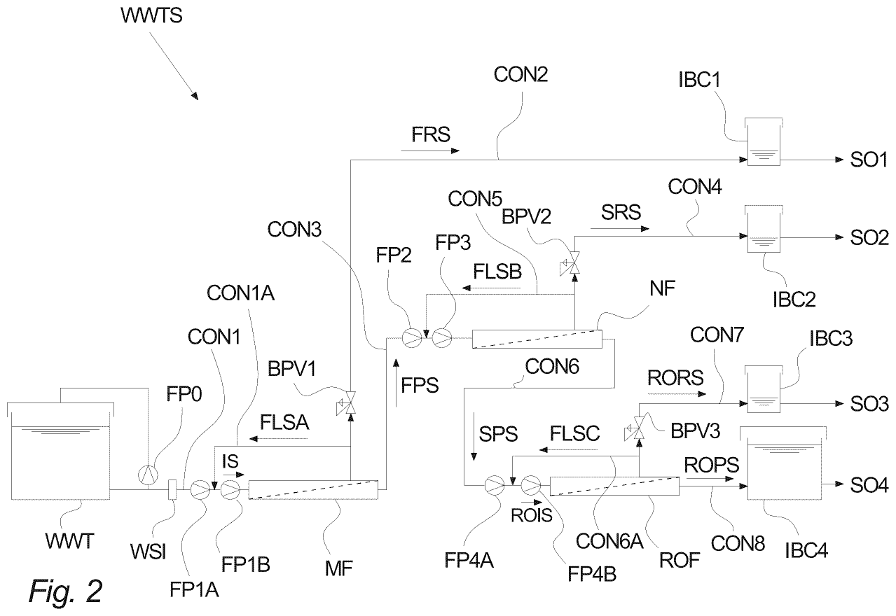

FIG. 2 illustrates principles of a wastewater treatment system, WWTS, and a wastewater treatment method according to an embodiment of the invention.

The wastewater treatment system, WWTS, comprises a wastewater system input, WSI, fluidly connected to a wastewater source, here a wastewater tank, WWT. Circulation in the wastewater tank WWT is obtained through a fluid pump FPO.

The system input, WSI, channels an input stream, IS, to a microfilter, MF, via a conduit, CON1, and fluid pumps, FP1A and FP1B.

The microfilter, MF, may be formed as a tubular membrane filter, a flat sheet membrane filter, a hollow fiber filter, a rotating discs filter, etc.

The pore size may typically be within a range of 5 nm to 60 nm. In the present embodiment, the pore size is chosen to be 20 nm.

The microfilter, MF, splits the input stream, IS, into a first retentate stream, FRS, and a first permeate stream, FPS. The first retentate stream, FRS, is channeled through a back pressure valve, BPV1, to an intermediate bulk container, IBC1, via a conduit, CON2. From the intermediate bulk container, IBC1, a first system output, SO1, may be released.

A recirculation loop stream FLSA is channeled through the fluid pump FP1B back into the micro-filter, MF, via a conduit, CON1A from the first retentate stream, FRS.

The first permeate stream, FPS, is channeled through two fluid pumps, FP2 and FP3, to a nano-filter, NF, via a conduit, CON3.

The nano-filter, NF, splits the first permeate stream, FPS, into a second retentate stream, SRS, and a second permeate stream, SPS.

A recirculation loop stream FLSB is channeled through the fluid pump FP3 back into the nano-filter, NF, via a conduit, CON5 from the second retentate stream, SRS.

The second retentate stream, SRS, is channeled through a back pressure valve, BPV2, to an intermediate bulk container, IBC2, via a conduit, CON4. From the intermediate bulk container, IBC2, a second system output, SO2, may be released.

The second permeate stream, SPS, is channeled through fluid pumps, FP4A and FP4B, to a reverse osmosis filter, ROF, via a conduit, CON6. The feed-back arrangement described above serves the purpose of reducing the water content of the second retentate stream, SRS, to an acceptable level.

The reverse osmosis filter, ROF, splits a reverse osmosis input stream ROIS derived from the second permeate stream, SPS, a recirculation loop stream FLSC into a reverse osmosis retentate stream, RORS, and a reverse osmosis permeate stream, ROPS. The reverse osmosis retentate stream, RORS, is channeled through a back pressure valve, BPV3, to an intermediate bulk container, IBC3, via a conduit, CON7. From the intermediate bulk container, IBC3, a third system output, SO3, may be released.

The recirculation loop stream FLSC is channeled through the fluid pump FP4B back into the reverse osmosis filter, ROF, via a conduit, CON6A from the reverse osmosis retentate stream, RORS.

From the intermediate bulk container, IBC3, a third system output, SO3, may be released. The reverse osmosis permeate stream, ROPS, flows from the reverse osmosis filter output to an intermediate bulk container, IBC4, via a conduit, CON8. From the intermediate bulk container, IBC4, a fourth system output, SO4, may be released.

It should be noted that the above system outputs SO1-SO4 are associated with respective intermediate bulk containers in the present context. Some or all of the side streams may also, if desired, be channeled to the system output directly.

The system output SO1 may e.g. form a water-based stream of carbon compounds which may be subject to anaerobic treatment for the purpose of producing biogas via a biogas reactor (not shown).

The system output SO2 may e.g. also include carbon compounds and other compounds, such as ions. This output may be further processed into valuable products, or may be subject to biological treatment, e.g. aerobic treatment.

The system output SO3 should typically have a relatively low content of carbon compounds, but may include salts, metals etc., which e.g. may be reused in industrial processes, e.g. with a feedback to a tanning process step. The system output SO3 may be subject to post treatment. See notes to optional post processing types elsewhere in this application.

The system output SO4 may provide the “cleanest” side stream which e.g. may be reused in industrial processes.

It should be further noted that the use of an initial microfilter serves the purpose of protecting subsequent filtering elements from fouling and thereby reduces the need for maintenance of these downstream filtering elements.

The above illustrated filters, in particular the microfilter MF may be cleaned from fouling by known measures, e.g. by cleaning in place (CIP: Cleaning in place). It is however noted that the illustrated method/system facilitates a relatively low cleaning frequency of the filtering elements downstream of the microfilter (MF).

The microfilter MF could also be back-flushed with water in order to reduce the CIP expenses.

The filtering elements applied in the system will typically be crossflow membranes in order to fit into an industrial process with a relevant yield/acceptable maintenance frequency.

It should be noted that besides the organic compounds in the first retentate stream FRS, the microfilter MF may also sort out other stuff than organic compounds such as everything larger than e.g. 60 nm such as hair, solid particles, sand, clay, etc. to the retentate.

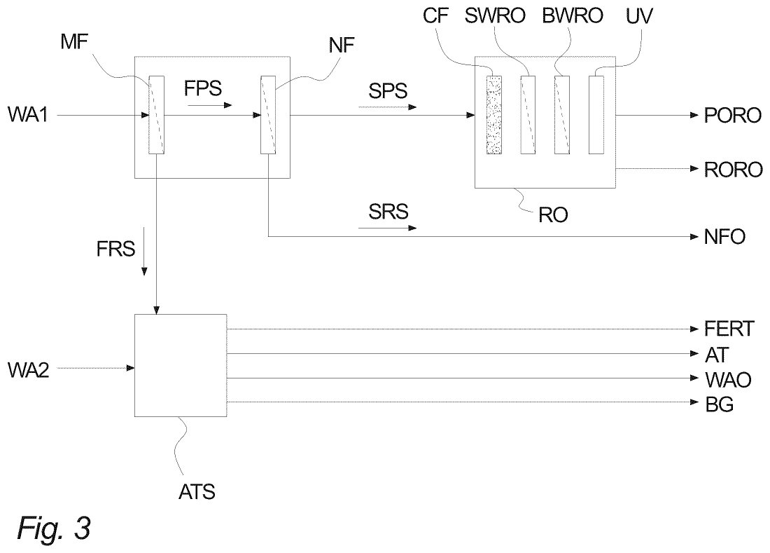

FIG. 3 illustrates an embodiment specifically relevant in connection with treatment of a soaking/bating effluent from a tanning process.

A first waste stream WA1 is thus fed to a microfilter MF, splitting the waste stream into a first permeate stream FPS and a first retentate stream FRS.

The first retentate stream FRS and a second waste stream WA2 is fed to an anaerobic treatment system ATS including a biogas reactor (not shown). This anaerobic treatment system provides biogas output BG, a waste output WAO, a fertilizer output FERT and another output AT, which may be subjected to aerobic treatment.

Turning to the first permeate stream FPS, this is channeled to a nano-filter NF, which again splits the first permeate stream into two side streams, a second permeate stream SPS and a second retentate stream SRS. The second retentate stream SRS is fed to a nano-filter output NFO. Subsequently, the second retentate stream may be subjected to an aerobic treatment.

The second permeate stream SPS is channeled via a further filtering arrangement RO giving rise to a permeate side stream of cleaned water, PORO, and a retentate output, RORO, delivering a side stream comprising salt. The retentate output may in the illustrated embodiment be fed back to a tanning process step and be used in connection with a pickling step.

The filtering arrangement RO delivering the above output may comprise a cascaded carbon filter CF, a seawater reverse osmosis filter SWRO, and a brackish water reverse osmosis filter BWRO. Moreover, the permeate may subsequently be subject to UV treatment by a UV filter, UV. The order of the filters, CF, SWRO and BWRO and the UV treatment may vary within the scope of the invention. Some of the filters may also be omitted and further filters may be added.

The first side stream in the present embodiment will be an effluent from a soaking/bating step of a tanning process, e.g. as illustrated in FIG. 1a.

The second waste stream WA2 comprises a wastewater stream with a relatively high concentration of protein and optionally other organic compounds. The second wastewater stream WA2 may e.g. be based on fleshing originating from a mechanical treatment of hides performed somewhere prior to the tanning step.

It should be noted that a pre-treatment and/or a post-treatment may be relevant or advantageously applied in connection with any of the above embodiments in FIG. 1A, FIG. 1B, FIG. 2 and FIG. 3. The pre-treatment(s) and/or post-treatment(s) are not shown in any of the drawings.

Both the pre-treatment(s) and/or the post-treatment(s) may be adapted to associated specific industrial process(es) producing the wastewater. The embodiment of FIG. 3 specifically refers to treatment of wastewater from a tanning process combined with a wastewater input of remnants from a mechanical processing of hides prior to the tanning process. The pore size of the applied filters may vary, in particular in relation to the microfilter, for different types of industrial process waste streams.

Relevant pre-treatment may include, but are not limited to: Prefiltering with a filter/mesh having larger pores/opening than the pores of the initial microfilter MF or e.g. a cyclone filter, thereby facilitating e.g. removal of unwanted larger particles.

Another type of an applicable pre-treatment may include chemical/physical treatments such as flocculation, coagulation, and/or pH adjustment such as acid treatment and ion-exchange.

Relevant types of post-treatments may include, but are not limited to, UV radiation, filtering by an activated carbon filter, chemical treatment by e.g. chlorine, ozone, hydrogen peroxide. The three latter treatments may preferably be performed on the retentate stream and/or the permeate stream from the reverse osmosis filter, whereas the treatment performed by UV radiation and/or the activated carbon filter may be performed on e.g. sub streams prior to the reverse osmosis filter, e.g. the input stream to the reverse osmosis filter. A further post-treatment type may be an ammonia removal step, such as an ion exchange treatment.

Moreover, the above embodiments in FIG. 1A, FIG. 1B, FIG. 2 and FIG. 3 may advantageously include one or more additional buffer tanks (not shown) to ensure an effective performance of the system.

Moreover, the above embodiments in FIG. 1A, FIG. 1B, FIG. 2 and FIG. 3 may advantageously include a biological treatment, e.g. an aerobic treatment, on the first permeate stream or further permeate streams downstream of the microfilter MF to reduce small remnants of undesired compounds.

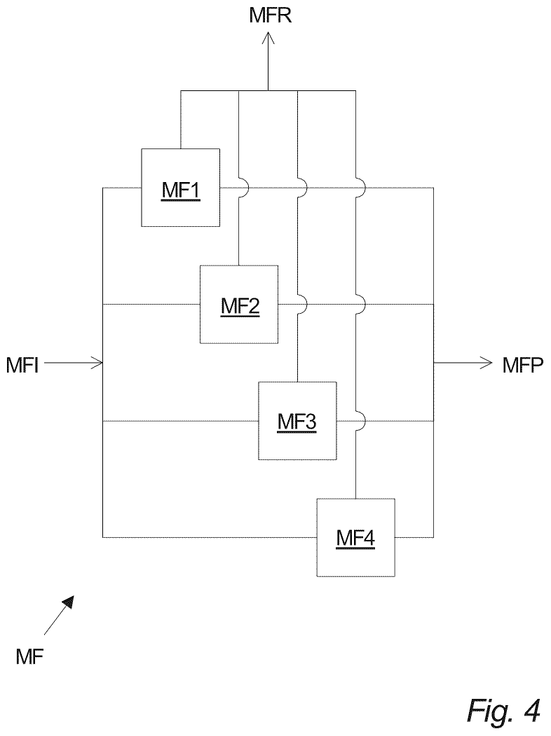

FIG. 4 illustrates a microfilter, MF, having four different microfilter subunits, MF1, MF2, MF3 and MF4 with equal filtration capacities. A microfilter input stream, MF1, enters the microfilter, MF, whereby it is being split into four equal-sized sub-streams. Each sub stream is then directed to a microfilter subunit (MF1, MF2, MF3 or MF4) by which it is being filtered and split into a retentate stream and a permeate stream. The four retentate streams are being collected from each microfilter subunit and merged into one microfilter retentate, MFR, leaving the microfilter via an output. Similarly, the four permeate streams are being collected from each microfilter subunit and merged into one microfilter permeate, MFP, leaving the microfilter through another output. By having more than one microfilters (here a four-unit microfilter), cleaning and maintenance can be performed by a cleaning-in-place, CIP, procedure in which one microfiltration subunit at a time can be shut off and cleaned. This may facilitate a filtration capacity at or above 75%, and the filtration flow can thus continue uninterrupted during maintenance.

If the illustrated parallel microfilter MF is applied in the embodiments of FIG. 2 or 3, the efficiency of the overall system may be kept relatively high as the microfilter may remove compounds (retentate) which would otherwise result in fouling of the downstream filters.

The concept of parallel membranes as explained above can be applied for the other filtering elements too, not only for microfiltration, e.g. for downstream nano-filters and/or reverse osmosis filters if so desired.

1. A method of filtering tannery wastewater, the method including steps of:
micro filtering a wastewater input of the tannery wastewater in at least one microfilter thereby splitting the tannery wastewater input into a first retentate stream comprising organic compounds and a first permeate stream,
establishing, on the basis of said first permeate stream or a derivative thereof, a reverse osmosis input stream (ROIS),
performing, on the basis of said reverse osmosis input stream, a reverse osmosis filtering by a reverse osmosis filter thereby establishing a reverse osmosis retentate stream and a reverse osmosis permeate stream, and
wherein the tannery wastewater comprises one or more side streams of a tanning process.

2.-5. (canceled)

6. The method of filtering the tannery wastewater according to claim 1, wherein the effluent is provided from one or more tanning process steps of the tanning process, such as soaking, liming, deliming, bating, pickling, tanning, dyeing, or fat liquoring.

7. The method of filtering the tannery wastewater according to claim 1, wherein a content of the organic compounds in the first retentate stream is at least 25% by weight of said wastewater input.

8. The method of filtering the tannery wastewater according to claim 1, wherein the first retentate stream and/or the derivative thereof is subjected to anaerobic digestion.

9.-15. (canceled)

16. The method of filtering the tannery wastewater according to claim 1, wherein at least the first retentate stream or a derivative thereof is applied for production of biogas and/or other biofuels.

17.-25. (canceled)

26. The method of filtering the tannery wastewater according to claim 1, wherein effluents from a soaking and a bating step of the tanning process are combined.

27.-31. (canceled)

32. The method of filtering the tannery wastewater according to claim 1, wherein at least one of the first retentate or the first permeate streams is fed back to an industrial process.

33.-35. (canceled)

36. The method of filtering the tannery wastewater according to claim 1, wherein the microfilter is implemented with one or more crossflow filtering elements.

37. The method of filtering the tannery wastewater according to claim 1, wherein a pore size of the microfilter is between 5 nm and 2 micrometers.

38. The method of filtering the tannery wastewater according to claim 1, wherein at least one further filter comprises an ultrafilter, and
wherein the ultrafilter is implemented with one or more crossflow filtering elements.

39. The method of filtering the tannery wastewater according to claim 38, wherein a pore size of the ultrafilter is between 0.1 nm and 2 micrometers.

40. The method of filtering the tannery wastewater according to claim 1, wherein at least one further filter comprises a nano-filter, and
wherein a pore size of the nano-filter is between 150 Da (Dalton) and 1000 Da.

41.-42. (canceled)

43. The method of filtering the tannery wastewater according to claim 1, wherein a pore size of the reverse osmosis filter is less than 150 Da.

44.-49. (canceled)

50. The method of filtering the tannery wastewater according to claim 1, wherein an anti-microbial treatment is variably turned on and off in dependency of a microorganism level in a water stream.

51.-53. (canceled)

54. The method of filtering the tannery wastewater according to claim 1, wherein the tannery wastewater has not been subjected to aerobic pretreatment prior to the step of micro filtering.

55. The method of filtering the tannery wastewater according to claim 1, wherein said microfilter is subject to a cleaning-in-place, and
wherein the microfilter is cleaned at least one time every 7 days.

56. The method of filtering the tannery wastewater according to claim 1, wherein a content of chemical oxygen demand of the wastewater input is 1 to 50 gram per liter.

57. A tannery wastewater treatment system, comprising:
at least one wastewater system input that is fluidly connected with a micro filter,
wherein the micro filter is further fluidly connected with a first conduit for channeling of a first retentate stream or a derivative thereof to a first system output,
wherein the micro filter is further fluidly connected with a second conduit for channeling of at least a side stream of a first permeate stream via one of more intermediate filters to at least one reverse osmosis filter, and
wherein the reverse osmosis filter provides at least one reverse osmosis permeate stream to a second system output.

58. (canceled)

59. The tannery wastewater treatment system according to claim 57, wherein said micro-filter is fluidly connected with a conduit for channeling of a side stream of a first permeate stream or a derivative thereof to a third system output via at least one intermediate filter.

60. The tannery wastewater treatment system according to claim 57, wherein said first retentate stream or at least a side stream thereof is channeled to the first system output via one or more filters.

61. (canceled)
